(19) United States
(12) Patent Application Publication
(10) Pub. No.: US 2023/0031724 A1
(43) Pub. Date: Feb. 2, 2023

(54) COMPUTERIZED SYSTEMS AND METHODS FOR AN AUDIO AND SOCIAL-BASED ELECTRONIC NETWORK

(71) Applicant: SONG MATES, INC., Columbia City, IN (US)

(72) Inventors: Katina Houser, Columbia City, IN (US); Richard Forbes Taylor, Stamford, CT (US); Caitlin Alexander, Greeley, CO (US)

(21) Appl. No.: 17/874,506

(22) Filed: Jul. 27, 2022

Related U.S. Application Data
(60) Provisional application No. 63/226,100, filed on Jul. 27, 2021.

(51) Int. Cl. H04N 21/442; H04N 21/439; H04N 21/262

(52) U.S. Cl. CPC H04N 21/44226; H04N 21/4394; H04N 21/26258; G06Q 50/01

(57) ABSTRACT

The disclosed systems and methods provide a novel framework that assembles a musical profile for a user based on the user's musical tastes and experiences, whereby digital relationships can be established based therefrom which enables digital and real-world interactions between users of such relationships. The disclosed framework provides social-based functionality for discovering individuals as well as new forms of music content. The framework combines social networking functionality with music streaming functionality in a novel way that enables users to discover each other based on music renderings, as well as discover additional music to render. The disclosed systems and methods, therefore, provide a novel way for connecting users on a deeper level than previously existed prior to the advent of the disclosed audio and social-based electronic network, which enables cross-demographic, music-based compatibility to drive user engagement, and user and content discovery.

### CROSS-REFERENCE TO RELATED APPLICATION

This application claims the benefit and priority to U.S. Provisional Application No. 63/226,100, filed Jul. 27, 2021, the entire contents of which are incorporated herein by reference.

This application includes material that is subject to copyright protection. The copyright owner has no objection to the facsimile reproduction by anyone of the patent disclosure, as it appears in the Patent and Trademark Office files or records, but otherwise reserves all copyright rights whatsoever.

### FIELD

The present disclosure relates generally to a mechanism for an electronic social network, and more particularly, to providing an application-based social network that determines and facilitates electronic connections between users derived from compiled music tastes and/or experiences.

### BACKGROUND

Conventional social networks compile information about a user. This information can be collected from input provided by a user, and/or derived from online and/or real-world activities of the user. In some respects, users can develop relationships by manually identifying other users to match with, and in some respects, users can be suggested to one another based on matches of their profiles.

### SUMMARY

The disclosed systems and methods provide a framework that provides a novel aspect upon which a social or other network can be based. According to some embodiments, as discussed herein, the disclosed systems and methods provide a framework that connects users looking for buddies, dates or love (e.g., other users) through shared musical tastes and experiences. According to some embodiments, the disclosed systems and methods provide a framework that evaluates and connects users in a wide variety of contexts including, without limitation, social, dating, team building, employment, and other contexts.

For purposes of this disclosure, music (e.g., audio data and/or metadata) will be the focus of the basis for profile generation and user matching, however, it should not be construed as limiting, as one of ordinary skill in the art would recognize that any other type of media, media information and/or content object of information (e.g., movies, television shows, podcasts, and the like) can be used within the disclosed framework for profile generation and user matching without departing from the scope of the instant disclosure.

According to some embodiments, as discussed below, the framework operates by developing a “songstory” for a user, then actively operating to discover and/or enabling users the ability to discover “songmates.” According to the instant disclosure, a “songstory” can be a timeline or sequential listing of information that corresponds to a user's musical tastes, listening history and/or musical data that corresponds to events from the user's past and present (and, in some embodiments, the future (e.g., a bachelorette party is planned and a playlist is pre-designated for this event). In other words, a songstory can be viewed as an autobiographical playlist of a user's life through music.

According to some embodiments, a songstory can include, but is not limited to, temporal, spatial, social and/or logical information related to, but not limited to, music purchases, events in a user's life, musical tastes at points in life, and/or any other type of event in a user's life where music information can be derived or identified, or some combination thereof. For example, a songstory can indicate which album was the first album the user first purchased, which playlist the user listened to when applying for a job, which songs were the user's favorite as a freshman in college, which songs are her favorite songs currently to listen to when exercising, and the like. Thus, a songstory can be viewed as a type of musical timeline for a user, as depicted in FIG. 5.

For example, FIG. 5 illustrates a non-limiting example of a timeline 500 of a user's musical tastes and experiences (e.g., a digital mapping and depiction of a user's songstory). The depictions and discussion herein related to FIG. 5, the timeline 500 and/or the events 502-508 should not be construed as limiting, as a timeline can be digitally compiled and depicted within a user interface (UI) by any type of known or to be known application, program or methodology without departing from the scope of the instant disclosure. For example, events 502-508 can be depicted as a set of displayable interface objects that are scrollable either horizontally or vertically, and/or swipe-able such that a single interface object for an event is displayed each time a swipe (or other form of input) is received. One of skill in the art would understand that these other non-limiting examples are non-limiting with reference to the instant disclosure.

As illustrated in FIG. 5, timeline 500 depicts events 502-504 along an x-axis, which represents a time period that extends from left to right (e.g., the further traversing along the x-axis in a positive direction, this corresponds to the passing of time, at a scale to represent the event information for a user). In some embodiments, Each event 502-504 can be depicted as an interactive interface object. For example, event 502 can be selected whereby information related to the event can be displayed and/or additional information can be retrieved and displayed.

For example, event 502 corresponds to the first album the user purchased. In this example, this is displayed as the earliest event (e.g., temporally) on the timeline 500 because it may have been the first piece of musical data the user provided. A viewing user can select event 502's object, whereby the information (e.g., backstory, as discussed below) for the event 502 can be displayed. In some embodiments, the information can be displayed in a pop-up window, separate window, sidebar, audibly output, as a form of virtual or augmented reality (VR/AR), compiled as a message or notification and sent to the viewing user, and the like, or some combination thereof.

In some embodiments, selection of event 502, for example, can involve the compilation of additional information for display (in a similar manner as above). For example, the information about the album can be compiled into a query which is used to identify additional information about the musical event. For example, the album cover and/or lyrics of the songs on the album can be retrieved over a network (e.g., Internet) and can be displayed along with the user provided information.

In some embodiments, selection of event 502 can generate a search for similar content and/or content related to the music of the event 502. For example, a playlist can be compiled with the music associated with event 502 being the seed upon which other music is identified. In another example, music videos or social media posts related to the music of event 502 can be identified, retrieved and provided for display in association with timeline 500.

Therefore, in some embodiments, by way of a non-limiting example, events 502-504 can correspond to, but are not limited to, musical events observed in a user's provided lifetime—such as, first purchased album (e.g., event 502), music in a playlist the user listened to when applying for a job (event 504), which songs were the user's favorite as a freshman in college (e.g., event 506) and which songs are her favorite songs currently to listen to when exercising (e.g., event 508).

In some embodiments, events 502-508 can be color coded to correspond to a type of event. In some embodiments, the depiction of each event 502-508 can be include and/or be modified by a user, where, such included and/or added information can be related to, but is not limited to, selecting and/or changing a color, selecting and/or changing a shape, selecting and/or changing an answer or response, selecting and/or adding a content object for display within the event interface object, changing and/or providing linking information (e.g., a uniform resource locator (URL) to additional information), selecting and/or adding a feedback effect when selected (e.g., playing an audio track that corresponds to an event), selecting, changing and/or listening to music associated with a particular event, selecting, changing and/or watching related videos, selecting, changing and/or accessing lyrics, and the like, or some combination thereof.

According to some embodiments, a user profile can be generated, compiled and/or assembled for a user based on, but not limited to, the user's songstory. In some embodiments, a profile can further include other forms of information for a user, such as, for example, information related to a badge or other ID, as disclosed in U.S. Provisional Application No. 63/244,668, which is incorporated in its entirety herein by reference.

While the discussion herein will be based on matching users based on user profiles for users that includes their songstories, it should not be construed as limiting, as badge ID information and/or any other type of profile information can be utilized for profile generation, without departing from the scope of the instant disclosure.

As mentioned above and discussed below, once a songstory is compiled and user profile established for a user, “songmates” can be identified. A “songmate” corresponds to a match between users. As discussed below, according to some embodiments, songmates can be established based on threshold level similarity matching between users' songstories. By way of a non-limiting example, a songstory for user A and a songstory for user B are compared and it is determined that they have similar music event data in their lives that corresponds to a potential match. For example, their favorite artist (e.g., derived from their music event data of their songstories) is the same. In some embodiments, this match can be for love, finding new friends, finding dates, looking for advice, and the like. The match can be suggested to each user, and upon user A and user B approving the match, they can become songmates.

In some embodiments, being a songmate with another user can enable additional functionality to be provided to the user(s). For example, users can now directly message each other, like events on another users' songstory (e.g., timeline 500, for example), view profile information, track and/or request each other's location, share music (e.g., send music, send specifically crafted playlists (referred to as “mixtapes”) and/or record and share audio recordings, and the like), share “tokens”, conduct instant messaging, video and/or telephonic chats, and the like. In some embodiments, the access to a user's profile and/or interactive information provided by a songmate relationship can be governed by security settings, which can be set by a user, an administrator, the application, a content provider and the like, or some combination thereof.

According to some embodiments, a “token” is a digital vale or electronic “currency” that users can share and/or utilize to view matches, play music, share content (e.g., send music to a songmate or potential/recommended songmate), and the like or some combination thereof. In some embodiments, a quantity of tokens a user has for a predetermined period of time can correspond to a subscription level of the user. For example, if the user is a “free” (or non-paying user), then 10 tokens per month can be provided to the user. These can be used to play music, view matches and/or share content with songmates, for example. If the user is a “VIP” member, then the user can have 100 tokens to perform similar tasks. In some embodiments, additional tokens can be provided to users based on payment, rewards, location, and/or any other type of mechanisms in which users can be provided and/or rewarded for usage of an application, and the like. Thus, in some embodiments, availability to functionality within the application associated with the disclosed framework can be controlled by and/or limited to management of tokens.

Thus, according to some embodiments, the disclosed framework provides systems and methods for assembling a musical profile for a user that evidences a user's musical tastes and experiences, whereby songmates can be established based therefrom which enables digital and real-world interactions between such songmates. As evident from the disclosure herein, some embodiments of the disclosed framework provide social-based functionality for discovering individuals as well as new forms of music content. The framework combines social networking functionality with music streaming functionality in a novel way that enables users to discover each other based on music renderings, as well as discover additional music to render. The disclosed systems and methods, therefore, provide a novel way for connecting users on a deeper level than previously existed prior to the advent of the disclosed audio and social-based electronic network, which enables cross-demographic, music-based compatibility to drive user engagement, and user and content discovery.

In accordance with one or more embodiments, the present disclosure provides computerized methods for a novel framework that provides an electronic social networking application and/or platform that is based on connections between users derived from compiled music tastes and/or experiences.

In accordance with one or more embodiments, the present disclosure provides one or more non-transitory computer-readable storage media for carrying out the above mentioned technical steps of the framework's functionality. The one or more non-transitory computer-readable storage medium has tangibly stored thereon, or tangibly encoded thereon, computer readable instructions that when executed by one or more computers (e.g., a client device) cause one or more processors to execute an algorithm that includes steps for a novel and improved framework that provides an electronic social networking application and/or platform that is based on connections between users derived from compiled music tastes and/or experiences. In some embodiments, the algorithm is represented by the recited steps and/or associated flowcharts, where one of ordinary skill would understand how to code the steps for various systems.

In accordance with one or more embodiments, a system is provided that comprises one or more computes configured to provide functionality in accordance with such embodiments. In accordance with one or more embodiments, functionality is embodied in steps performed by at least one computer. In accordance with one or more embodiments, program code (or program logic) executed by one or more processors of a computer to implement functionality in accordance with one or more such embodiments is embodied in, by and/or on a non-transitory computer-readable medium.

In some embodiments, the system comprises one or more computers comprising one or more processors and one or more non-transitory computer readable media, the one or more non-transitory computer readable media comprising instructions stored thereon that when executed cause the one or more computers to implement steps. In some embodiments, the steps include displaying, by the one or more processors, a request for first information of a first user on a graphical user interface (GUI) of a first electronic device. In some embodiments, the steps include generating, by the one or more processors, a first profile including one or more visual representations of one or more portions of a first identity of the first user and/or one or more first user interests. In some embodiments, the steps include compiling, by the one or more processors, a query of one or more other user profiles, the query configured to enable a match between the first profile and at least a second profile of a second user. In some embodiments, the steps include determining, by the one or more processors, overlapping interest between the first user and the second user. In some embodiments, the steps include returning a match if the overlapping interests exceed a certain threshold.

In some embodiments, the one or more visual representations include a songstory. In some embodiments, the songstory includes a timeline. In some embodiments, the songtory includes one or more musical preferences. In some embodiments, the songstory includes at least one timeline. In some embodiments, the songtory includes one or more musical preferences.

In some embodiments, the one or more musical preferences include one or more songs. In some embodiments, the timeline comprises one or more life events. In some embodiments, songstory comprises a visual representation of the one or more songs at intervals along the timeline. In some embodiments, the one or more songs are each associated with at least one of the one or more life events on the timeline. In some embodiments, the songstory includes a discography.

In some embodiments, the steps include presenting, by the one or more processors, an option on the GUI for the first user to approve the match. In some embodiments, the steps include designating, by the one or more processors, the first user and the second user as songmates. In some embodiments, the designation enables interaction and sharing of content between the songmates.

In some embodiments, the steps include generating, by the one or more processors, a scraping of a first social media history of the first user. In some embodiments, the steps include generating, by the one or more processors, at least part of the songstory based on the scraping. In some embodiments, the steps include generating, by the one or more processors, a match type input on the GUI. In some embodiments, the match type input comprises a type of relationship the first user desires to form.

### BRIEF DESCRIPTION OF THE DRAWINGS

The foregoing and other objects, features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1 is a schematic diagram illustrating an example of a network within which the systems and methods disclosed herein could be implemented according to some embodiments of the present disclosure;

FIG. 2 depicts is a schematic diagram illustrating an example of client device in accordance with some embodiments of the present disclosure;

FIG. 3 is a block diagram illustrating components of an exemplary system in accordance with some embodiments of the present disclosure;

FIG. 4 is a block diagram illustrating an exemplary data flow in accordance with some embodiments of the present disclosure;

FIG. 5 illustrates a non-limiting example of a timeline that forms a basis of a user's songstory that can be used to discover songmates in accordance with some embodiments of the present disclosure;

FIG. 6 is a block diagram illustrating an exemplary data flow in accordance with some embodiments of the present disclosure; and

FIG. 7 is a block diagram illustrating an exemplary data flow in accordance with some embodiments of the present disclosure.

### DESCRIPTION OF EMBODIMENTS

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in some embodiments” as used herein is a reference to the system's ability to be described using various sections of a single system, where the metes and bounds of the system can be defined according to some embodiments described herein.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, are representations of computer algorithms and/or code that can be implemented by means of analog or digital hardware and computer program instructions. These computer program instructions can be executed by one or more processors of one or more computers as detailed herein In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure one or more non-transitory computer readable media stores computer data, which data can include computer program code (or computer-executable instructions) that is executable by one or more computers, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

In some embodiments, the system includes a server. For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

In some embodiments, the system includes a network. For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine readable media, for example. A network may include the Internet, one or more local area networks (LANs), one or more wide area networks (WANs), wire-line type connections, wireless type connections, cellular or any combination thereof. Likewise, sub-networks, which may employ differing architectures or may be compliant or compatible with differing protocols, may interoperate within a larger network.

In some embodiments, the system includes a wireless network. For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further include a plurality of network access technologies, including Wi-Fi, Long Term Evolution (LTE), WLAN, Wireless Router (WR) mesh, or 2nd, 3rd, 4^{th} or 5^{th} generation (2G, 3G, 4G or 5G) cellular technology, mobile edge computing (MEC), Bluetooth, 802.11b/g/n, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computer (i.e., computing device) may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

In some embodiments, the system includes one or more clients. For purposes of this disclosure, a client (or consumer or user) device may include a computing device capable of sending or receiving signals, such as via a wired or a wireless network. A client (i.e., client device) may, for example, include a desktop computer or a portable device, such as a cellular telephone, a smart phone, a display pager, a radio frequency (RF) device, an infrared (IR) device a NFC device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

As discussed herein, reference to an “advertisement” should be understood to include, but not be limited to, digital media content embodied as a media item that provides information provided by another user, service, third party, entity, and the like. Such digital ad content can include any type of known or to be known media renderable by a computing device, including, but not limited to, video, text, audio, images, and/or any other type of known or to be known multi-media item or object. In some embodiments, the digital ad content can be formatted as hyperlinked multi-media content that provides deep-linking features and/or capabilities. Therefore, while some content is referred to as an advertisement, it is still a digital media item that is renderable by a computing device, and such digital media item comprises content relaying promotional content provided by a network associated party.

As discussed in more detail below, according to some embodiments, information associated with, derived from, or otherwise identified from, during or as a result a generation of a songstory, songmate and/or shared music, as discussed herein, can be used for monetization purposes and targeted advertising when providing, delivering or enabling such devices access to content or services over a network. Providing targeted advertising to users associated with such discovered content can lead to an increased click-through rate (CTR) of such ads and/or an increase in the advertiser's return on investment (ROI) for serving such content provided by third parties (e.g., digital advertisement content provided by an advertiser, where the advertiser can be a third party advertiser, or an entity directly associated with or hosting the systems and methods discussed herein).

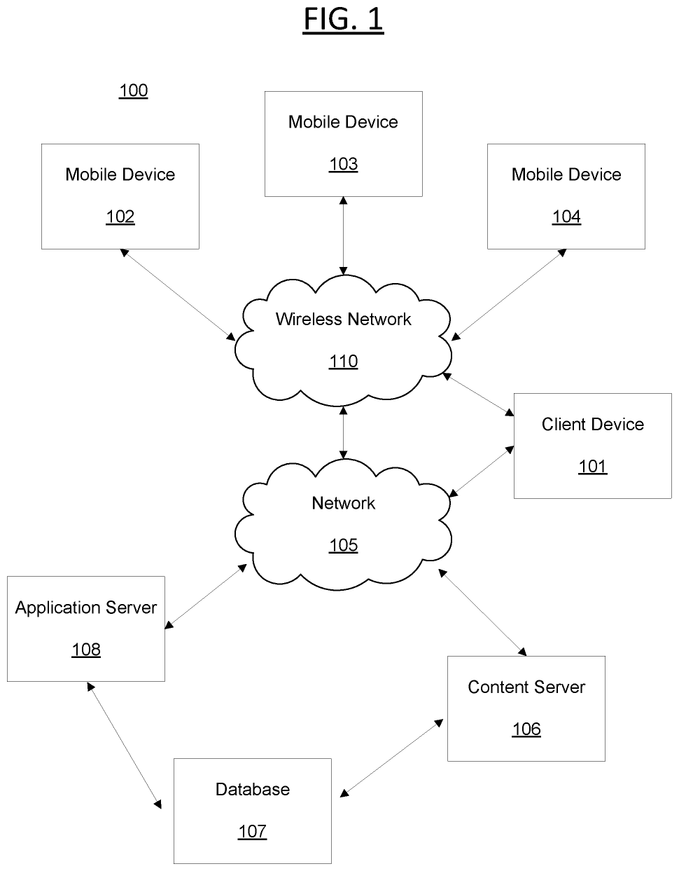

Certain embodiments will now be described in greater detail with reference to the figures. In general, with reference to FIG. 1, a system 100 in accordance with some embodiments of the present disclosure is shown. FIG. 1 shows components of a general environment according to some embodiments in which the systems and methods discussed herein may be practiced. Not all the components may be required to practice the disclosure, and variations in the arrangement and type of the components may be made without departing from the spirit or scope of the disclosure. In some embodiments, system 100 of FIG. 1 includes one or more of local area networks (“LANs”)/wide area networks (“WANs”)—network 105, wireless network 110, mobile devices (client devices) 102-104 and client device 101. In some embodiments, the system includes one or more of a variety of servers, such as content server 106 and application (or “App”) server 108.

In some embodiments, mobile devices (i.e., mobile computers) 102-104 may include virtually any portable computing device (i.e., portable computer) capable of receiving and sending a message over a network, such as network 105, wireless network 110, or the like. Mobile devices 102-104 may also be described generally as client devices that are configured to be portable. Thus, mobile devices 102-104 may include virtually any portable computing device capable of connecting to another computing device and receiving information according to some embodiments.

In some embodiments, mobile devices 102-104 also may include at least one client application (App) that is configured to receive content from another computing device. In some embodiments, mobile devices 102-104 may also communicate with non-mobile client devices, such as client device 101, or the like. In some embodiments, such communications may include sending and/or receiving messages, searching for, viewing and/or sharing memes, photographs, digital images, audio clips, video clips, or any of a variety of other forms of communications.

In some embodiments, client devices 101-104 may be capable of sending or receiving signals, such as via a wired or wireless network, or may be capable of processing or storing signals, such as in memory as physical memory states, and may, therefore, operate as a server.

In some embodiments, wireless network 110 is configured to couple mobile devices 102-104 and its components with network 105. In some embodiments, wireless network 110 may include any of a variety of wireless sub-networks that may further overlay stand-alone ad-hoc networks, and the like, to provide an infrastructure-oriented connection for mobile devices 102-104.

In some embodiments, network 105 is configured to couple content server 106, application server 108, or the like, with other computing devices, including, client device 101, and through wireless network 110 to mobile devices 102-104. In some embodiments, network 105 is enabled to employ any form of computer readable media or network for communicating information from one electronic device to another.

In some embodiments, the content server 106 may include a device that includes a configuration to provide any type or form of content via a network to another device. In some embodiments, devices that may operate as content server 106 include personal computers, desktop computers, multiprocessor systems, microprocessor-based or programmable consumer electronics, network PCs, servers, and the like. In some embodiments, content server 106 can further provide a variety of services that include, but are not limited to, email services, instant messaging (IM) services, streaming and/or downloading media services, advertising services, proximity services, search services, photo services, web services, social networking services, news services, third-party services, audio services, video services, SMS services, MMS services, FTP services, voice over IP (VOIP) services, or the like.

In some embodiments, content server 106 can be, or may be coupled or connected to, a third party server that stores online advertisements for presentation to users. In some embodiments, various monetization techniques or models may be used in connection with sponsored advertising, including advertising associated with user data, as discussed below, where ads can be modified and/or added to content based on the personalization of received content using the locally accessible user profile.

In some embodiments, users are able to access services provided by servers 106 and/or 108. In some embodiments, this may include as non-limiting examples, authentication servers, search servers, email servers, social networking services servers, SMS servers, IM servers, MMS servers, exchange servers, photo-sharing services servers, and travel services servers, via the network 105 using their various devices 101-104.

In some embodiments, applications, such as, but not limited to, news applications (e.g., ESPN®, Huffington Post®, CNN®, and the like), mail applications (e.g., Yahoo! Mail®, Gmail®, and the like), instant messaging applications, blog, photo or social networking applications (e.g., Facebook®, Twitter®, Instagram®, and the like), search applications (e.g., Google Search®), and the like, can be hosted by the application server 108, or content server 106 and the like.

Thus, the application server 108 and/or content server 106, for example, can store various types of applications and application related information including application data and other various types of data related to the content and services in an associated content database 107, as discussed in more detail below. In some embodiments, the network 105 is also coupled with/connected to a Trusted Search Server (TSS) which can be utilized to render content in accordance with the embodiments discussed herein. In some embodiments, the TSS functionality can be embodied within servers 106 and/or 108.

Moreover, although FIG. 1 illustrates servers 106 and 108 as single computing devices, respectively, the disclosure is not so limited. For example, one or more functions of servers 106 and/or 108 may be distributed across one or more distinct computing devices in some embodiments. Moreover, in some embodiments, servers 106 and/or 108 may be integrated into a single computing device, without departing from the scope of the present disclosure.

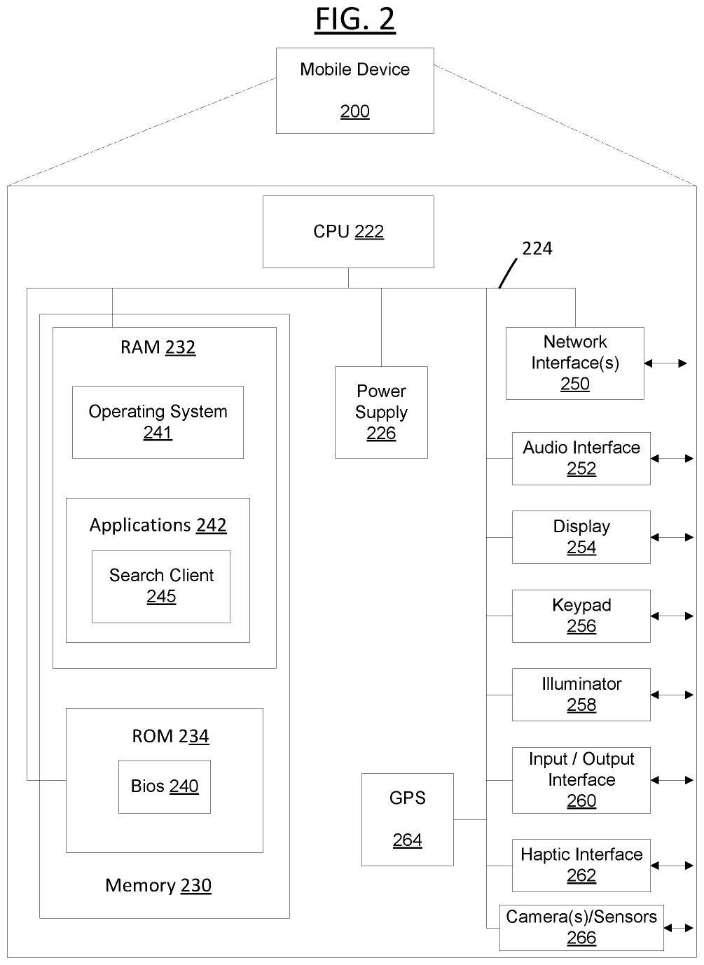

FIG. 2 is a schematic diagram illustrating a client device showing an example embodiment of a client device that may be used within the present disclosure according to some embodiments. In some embodiments, client device 200 may include many more or less components than those shown in FIG. 2. However, the components shown are sufficient to disclose an illustrative embodiment for implementing the present disclosure. In some embodiments, client device 200 may represent, for example, client devices 101-104 discussed above in relation to FIG. 1.

In some embodiments, Client device 200 includes a processing unit (CPU) 222 in communication with a mass (non-transitory) memory 230 via a bus 224. Client device 200 also includes a power supply 226, one or more network interfaces 250, an audio interface 252, a display 254, a keypad 256, an illuminator 258, an input/output interface 260, a haptic interface 262, an optional global positioning systems (GPS) receiver 264 and a camera(s) or other optical, thermal or electromagnetic sensors 266. In some embodiments, device 200 can include one camera/sensor 266, or a plurality of cameras/sensors 266, as understood by those of skill in the art. In some embodiments, power supply 226 provides power to Client device 200.

In some embodiments, client device 200 may optionally communicate with a base station (not shown), or directly with another computing device. In some embodiments, network interface 250 is sometimes known as a transceiver, transceiving device, or network interface card (NIC).

In some embodiments, audio interface 252 can be arranged to produce and receive audio signals such as, for example, the sound of a human voice. In some embodiments, display 254 includes a touch sensitive screen arranged to receive input from an object such as a stylus or a digit from a human hand. In some embodiments, keypad 256 can comprise any input device arranged to receive input from a user. In some embodiments, illuminator 258 may provide a status indication and/or provide light.

In some embodiments, client device 200 also comprises input/output interface 260 for communicating with external devices. In some embodiments, input/output interface 260 can utilize one or more communication technologies, such as USB, infrared, Bluetooth™, or the like. In some embodiments, haptic interface 262 is arranged to provide tactile feedback to a user of the client device.

In some embodiments, optional GPS transceiver 264 can determine the physical coordinates of client device 200 on the surface of the Earth. In some embodiments however, client device 200 may through other components, provide other information that may be employed to determine a physical location of the device, including for example, a MAC address, Internet Protocol (IP) address, or the like.

In some embodiments, mass memory 230 includes a RAM 232, a ROM 234, and/or other non-transitory storage media. In some embodiments, mass memory 230 stores a basic input/output system (“BIOS”) 240 for controlling low-level operation of client device 200. In some embodiments, the mass memory also stores an operating system 241 for controlling the operation of client device 200

In some embodiments, memory 230 further includes one or more data stores, which can be utilized by client device 200 to store, among other things, applications 242 and/or other information or data. For example, in some embodiments, data stores may be employed to store information that describes various capabilities of client device 200. In some embodiments, the information may then be provided to another device based on any of a variety of events, including being sent as part of a header (e.g., index file of the HLS stream) during a communication, sent upon request, or the like. In some embodiments, at least a portion of the capability information may also be stored on a disk drive or other storage medium (not shown) within client device 200.

Applications 242 may include computer executable instructions which, when executed by client device 200, transmit, receive, and/or otherwise process audio, video, images, and enable telecommunication with a server and/or another user of another client device. In some embodiments, applications 242 may further include search client 245 that is configured to send, to receive, and/or to otherwise process a search query and/or search result.

Having described the components of the architecture employed within the disclosed systems and methods, the components' operation with respect to the disclosed systems and methods will now be described below.

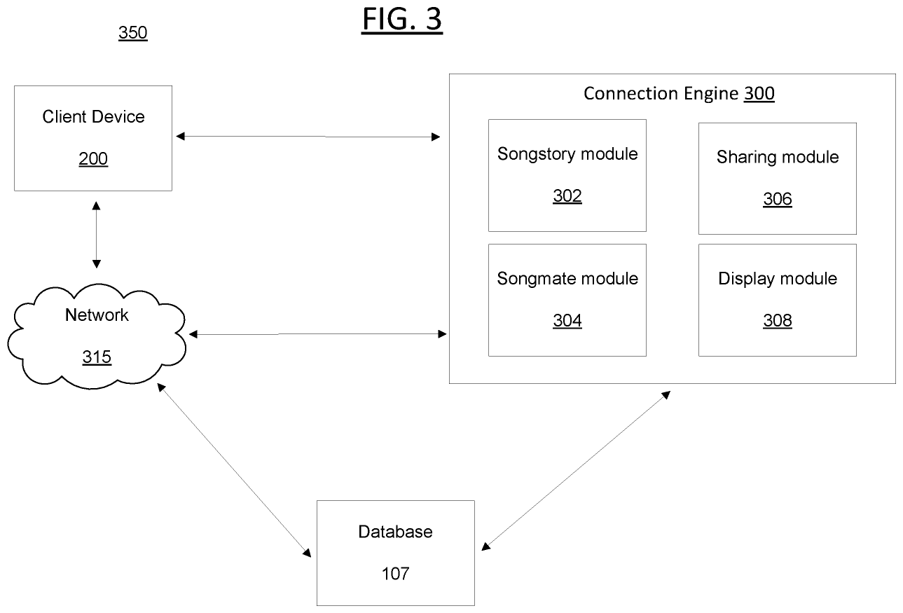

FIG. 3 is a block diagram illustrating the components for performing the systems and methods discussed herein according to some embodiments. FIG. 3 depicts system 350 which includes client device 200, connection engine 300, network 315 and database 107.

In some embodiments, connection engine 300 can be a machine or processor and could be hosted by device 200. In some embodiments, engine 300 can be hosted by a peripheral device connected to device 200. For example, in some embodiments, a peripheral device can be, but is not limited to, another mobile device, a transceiver, RFID tag, a display screen, wearable clothing or technology (e.g., smartwatch) and/or any other type of device that can be coupled to another device that functions as a single device, connected device configuration and/or Internet of Things (IoT) device configuration, and/or via any other type of known or to be known communication technique for devices to interact (e.g., NFC and/or IR, for example).

According to some embodiments, connection engine 300 can function as, or be associated with an application installed on device 200, and in some embodiments, such application can be a web-based application accessed by device 200 over network 315. In some embodiments, connection engine 300 can be configured and/or installed as an augmenting script, program or application (e.g., a plug-in or extension) to another application or portal data structure. In some embodiments, connection engine 300 can be hosted by a server on network 315, that is accessible by user devices and/or providing information for users for display on their devices.

In some embodiments, the database 107 can be any type of database or memory and can be associated with a server on a network 315 (e.g., content server, a search server or application server) or a user's device (e.g., device 101-104 or device 200 from FIGS. 1-2). In some embodiments, database 107 comprises a dataset of data and metadata associated with local and/or network information related to users, services, applications, content and the like.

In some embodiments, such information can be stored and indexed in the database 107 independently and/or as a linked or associated dataset, where an example of this is a look-up table (LUT). As discussed above, it should be understood that the data (and metadata) in the database 107 can be any type of information and type, whether known or to be known, without departing from the scope of the present disclosure.

According to some embodiments, database 107 can store data for users, e.g., user data. In some embodiments, the stored user data can include, but is not limited to, one or more of information associated with a user's profile, user interests, user behavioral information, user patterns, user attributes, user preferences or settings, user demographic information, user location information, user biographic information, and the like, or some combination thereof.

In some embodiments, the user data can also include user (client) device information, including, but not limited to, device identifying information, device capability information, voice/data carrier information, Internet Protocol (IP) address, applications installed or capable of being installed or executed on such device, and/or any, or some combination thereof. It should be understood that the data (and metadata) in the database 107 can be any type of information related to a user, content, a device, an application, a service provider, a content provider, whether known or to be known, without departing from the scope of the present disclosure.

According to some embodiments, database 107 can store data and metadata associated with users, searches, actions, renderings, clicks, conversions, previous recommendations, messages, images, videos, text, products, items and services from an assortment of media, applications and/or service providers and/or platforms, and the like. In some embodiments, any other type of known or to be known attribute or feature associated with a user, message, data item, media item, login, logout, event attendance, website, application, communication (e.g., a message) and/or its transmission over a network, a user and/or content included therein, or some combination thereof, can be saved as part of the data/metadata in datastore 107.

As discussed above with reference to FIG. 1, in some embodiments the network 315 can be any type of network such as, but not limited to, a wireless network, a local area network (LAN), wide area network (WAN), the Internet, or a combination thereof. In some embodiments, the network 315 facilitates connectivity of the connection engine 300, and the database of stored resources 107. In some embodiments, as illustrated in FIG. 3, the connection engine 300 and database 107 can be directly connected by any known or to be known method of connecting and/or enabling communication between such devices and resources.

In some embodiments, one or more processors, servers, and/or combination of devices that comprise hardware programmed in accordance with the functions described herein is referred to for convenience as connection engine 300, and includes songstory module 302, songmate module 304, sharing module 306 and display module 308. It should be understood that the engine(s) and modules discussed herein are non-exhaustive, as additional or fewer engines and/or modules (or sub-modules) may be applicable to some embodiments of the systems and methods discussed. The operations, configurations and functionalities of each module, and their role within some embodiments of the present disclosure will be discussed below.

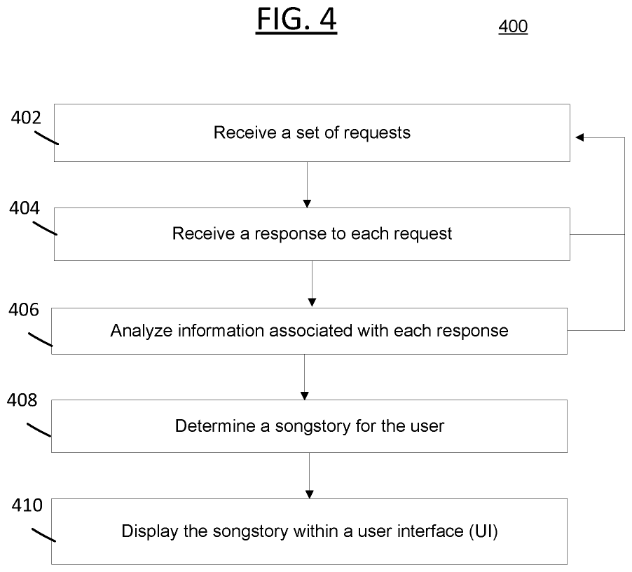

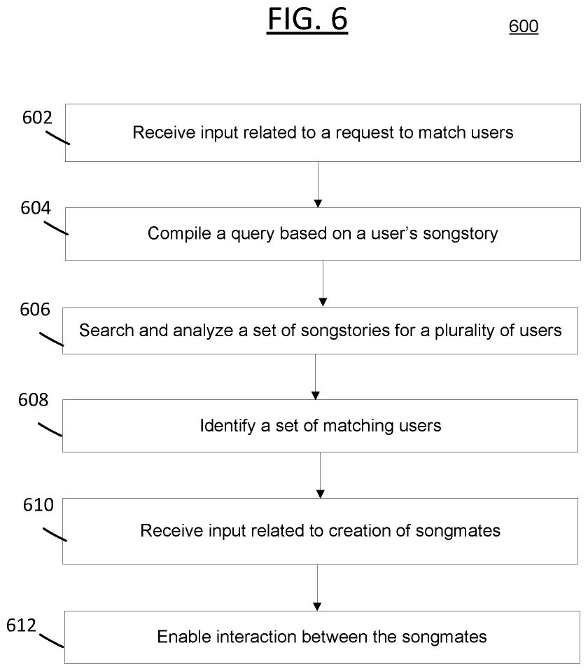

Turning to FIG. 4, Process 400 details a workflow for assembling a songstory for a user that can be displayed, interacted with, and/or leveraged for the identification of songmates and/or music-based interactions (as discussed below in relation to FIG. 6). According to some embodiments, Steps 402-408 can be performed by songstory module 302 of connection engine 300; and Step 410 can be performed by display module 308.

Process 400 begins with Step 402 where one or more requests related to generation of a songstory are provided. In some embodiments, the requests includes updating an existing songstory for a user. In some embodiments, the requests in Step 402 are configured to enable the system to identify music information related to events in a user's life (e.g., music listening to on first kiss, first album purchased, playlist when exercising, playlists made for friends, or current or previous partners, and the like).

In some embodiments, the one or more requests include questions or requests for identifying information related to a user. In some embodiments, the requests are open ended, where they enable a user to enter information in a free form manner. In some embodiments, the requests provide a selectable array of information for a user to choose from, which can be selected by any type of input, such as, but not limited to, a swipe, pinch, touch, force-touch, voice-input, eye-tracking, and the like, and/or any other type of input that known or to be known devices recognize as input or selection of an interface object displayed on a graphical user interface (GUI).

In some embodiments, the requests are configured to execute an automatic “scraping” of a user's profile to retrieve the desired information. In some embodiments, the user profile is associated with an application (App) associated with engine 300. In some embodiments, the user profile is also or alternatively associated with a third party application (e.g., a user's social media profile or music streaming profile—e.g., a Spotify® profile).

In some embodiments, the one or more requests are predefined. In some embodiments, the request are user generated and/or provided questions. In some embodiments, the requests are (dynamically) determined based on an initial (or seed) piece of information. For example, if the user indicates their favorite genre, the system is configured to generate a list of questions related to particular artists and/or events that correspond to artists' releases based on this information.

In some embodiments, the system is configured to provide one or more requests by one or more of an artist(s) and/or band(s), music streaming platform, label, third party social media platform and the like. In some embodiments, the system is configured to direct requests particular users (e.g., fans), based on one or more of a user's location and/or determined interest in a particular artist or genre, for example.

In Step 404, a response for each request from Step 404 is received. As discussed above, the response(s) can be entered by a user, and/or entered by selection from an array of choices or options. In some embodiments, the system is configured to enable the response(s) to be automatically retrieved from a user profile of the user. In some embodiments, the system is configured to enable a user to select a response and/or provide additional information (referred to as a “backstory”) that describes the event and/or reasoning for the music information (e.g., what the particular reasoning why this music was playing, for example).

In some embodiments, the interplay between Steps 402 and 404 can be recursive in that a request is provided (Step 402) and a response is received (Step 404), and Process 400 proceeds back to Step 402 to ask another request. In some embodiments, the system is configured to implement a threshold satisfying a number of recursive iterations between Steps 402-404. For example, in some embodiments, a minimum number of music events (e.g., 3) for a user may be required by the system to adequately represent their songstory.

In some embodiments, the system is configured to generate a different set of questions if a user declines to answer certain questions or requests. In some embodiments, another question may be retrieved or compiled, or another set of questions may be retrieved/compiled until a threshold amount of information about a user is collected.

In Step 406, the information received in the responses from Step 404 is analyzed by the system. According to some embodiments, the analysis performed by engine 300 in Step 406 is performed by an one or more of an artificial intelligence (AI) classifier (e.g., machine learning (ML), neural networks), algorithm, mechanism or technology, including, but not limited to, computer vision, cluster analysis, data mining, vector search engines, Bayesian network analysis, Hidden Markov models, logical models and/or tree analysis, and the like.

In some embodiments, Step 406 is executed each time a response is provided; and in some embodiments, Step 406 is performed on the whole or a portion of the responses from step 404. In some embodiments, the system is configured to wait until the threshold satisfying number of answers is provided, then proceed to performing the analysis. In some embodiments, in Step 406 whether the threshold is satisfied is indicated by the system, whereby further requests as in Step 402 can be executed based on the Step 406 analysis (as indicated by the arrow from Step 406 to Step 402).

In some embodiments, in Step 406 the system is configured to analyze the data and/or metadata related to the music information provided by and/or associated with each response of the user. For example, a user indicated that her first attend concert was in 1985, for “Van Halen”, and that her favorite song that year was “Panama” (for a set of 3 responses). In some embodiments, this information is analyzed and the system is configured to identify one or more other users with corresponding metadata and/or responses. In some embodiments, the system is configured to identify, as non-limiting examples, location data, social data from other users accounts that indicated they also attended the same concert, audio recordings of the concert, music and/or other content (e.g., related to the “1984” album) and the like.

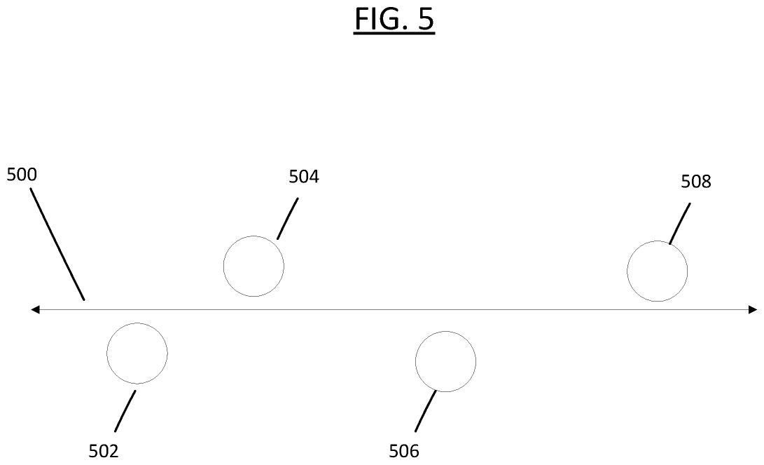

In Step 408, of the system is configured to generate a digital representation associated with a user, which is based on analysis from Step 406. In some embodiments, the digital representation, as illustrated in FIG. 5 (as discussed above), is the user's songstory. In some embodiments, the songstory provides a digital depiction of event data for music experiences/tastes of the user, where each event can be a node on the timeline, and each node can provide an interactive playback experience of data related to each corresponding event, and/or the discovery of additional information.

In some embodiments, the system is configured to generate a separate timeline for the user. In some embodiments, this separate timeline corresponds to a discography of the user. In some embodiments, the discography timeline functions similarly as the songstory, but rather than having personal information represented along with musical content, the discography includes musical content sequentially ordered by the system according to the temporal sequence of events provided by the user. Thus, in some embodiments, when a songstory is displayed and/or used for matching, the system is configured to use the discography in a similar manner without departing from the scope of the instant disclosure.

Continuing with Process 400, in Step 410, the system is configured to display the songstory a graphical user interface (GUI). In some embodiments, the GUI is associated with a device and/or application (e.g., App associated with engine 300). A non-limiting example of this is illustrated in FIG. 5 according to some embodiments. In some embodiments, step 410 includes the system sharing and/or posting the songstory to page of a third party website (e.g., post on the user's Facebook® page).

In some embodiments, the displayed songstory is interactive, as discussed above. In some embodiments, the system is configured to enable users to one or more of zoom in, zoom out, annotate, comment, link to third party sources (e.g., music charts or third party albums (e.g., Shutterfly®)), creation of musical libraries or memories, and the like, or some combination thereof.

According to some embodiments, the system is configured to display a songstory by a first user for which it is associated. In some embodiments, a songstory for a first user can be viewed by a second user (and/or a plurality of users), and such access by the system is based on searches and/or automatically identified matches, as discussed below. In some embodiments, the system is configured to display a songstory in conjunction with an event (e.g., a real-world event, for example—a public gathering at a park).

According to some embodiments, privacy settings can be set by a user and/or dynamically determined and applied by engine 300 based on profile information of the user that control how much, if any, information related to a user's songstory can be displayed to other users. For example, if a user is not songmates with other users, or if they are not at the same event, then the user's songstory may not be viewable, or only a portion of the data may be viewable, and/or a portion of it may be obfuscated until later approved (via songmate designation, as discussed below).

Turning to FIG. 6, Process 600 provides a non-limiting example embodiment of identifying a songmate and the functionality that is associated therewith. According to some embodiments, Steps 602-610 can be performed by songmate module 304 of connection engine 300; and Step 612 can be performed by sharing module 306.

Process 600 begins with Step 602 where input related to a request to match a user with at least one other user is received and/or identified by the system. In some embodiments, the input corresponds to a request for a match from a user. In some embodiments, the input indicates a request for a particular type of match, such as, but not limited to, a date, buddy, love and the like. In some embodiments, the input can be a general request and/or can be associated with a criteria, such as, but not limited to, experiences (e.g., same concerts, for example) and/or musical taste (e.g., music context). In some embodiments, the request can also or alternatively be based on location, age range, orientation, gender expression, identity, and the like. In some embodiments, the request can be based on information related to users' badge IDs.

In some embodiments, the input can correspond to an automatically detected criteria being satisfied. For example, the criteria can correspond to, but is not limited to, a location of a user, a type of activity of the user, proximity to another location and/or other user, subscription level, a response from another request from another user, and any other type of trigger that can cause a search to be performed for matching users, or some combination thereof.

In Step 604, a query is compiled based on the user's songstory. The query can include, but is not limited to, characters, a character string, numerals, Boolean logic, integers, vectors, tags, annotations, and/or any other type of data or metadata that can be included in a search query to search a data store of information. In some embodiments, the system is configured to compile the query based on analysis of the songstory of the user. In some embodiments, the analysis can be performed in a similar manner as discussed above in relation to Step 406 of Process 400. In some embodiments, the query at least represents music interest data for the user as provided by the songstory.

In some embodiments, as mentioned above, the query and subsequent matching are further based on, and/or alternatively based on discography information for the user and other users. For purposes of this disclosure, reference will focus on songstory data; however, it should not be construed as limiting as usage of additional timeline data and/or additional timeline(s) would not depart from the scope of the instant disclosure.

In Step 606, a search is performed based on the compiled query. In some embodiments, the search is configured to analyze information (e.g., songstory or profile information of other users) based on the data within the query, and, in Step 608, results in the identification of a set of matching users by the system. In some embodiments, the matching users at least have a similar musical context to the user as determined by the system. In some embodiments, this involves similar musical tastes (e.g., same genre, artist or related artists) for similar events and/or time periods. Thus, in Step 606, a context of other users are identified, and matched to a context of the user's songstory as provided for in the search query.

In some embodiments, searching and matching of users, as in Steps 606-608 are performed using similar computational analysis techniques discussed above in relation to Step 406 of Process 400.

For example, in some embodiments, Step 604 includes involve translating the user's songstory to a n-dimensional vector. In some embodiments, the n-dimensional vector forms the basis of the search in Step 606, and as a result of vector analysis algorithms applied to vectors of other users' songstories, for example, a set of other users can be identified, as in Step 608.

In some embodiments, Step 608 further involves outputting the matching users to the user by displaying them within a GUI of an application (that can be associated with engine 300). In some embodiments, this involves displaying their respective songstories, profile information, badge IDs, and the like, or some combination thereof. In some embodiments, as discussed above, presentation of a songstory, for example, enables a viewing user to interact with, view and/or render content represented and/or accessible by the songstory. For example, the system is configured to enable a user to listen to a song that is digitally represented on another user's songstory/timeline. In some embodiments, the system is configured to enable selection of an item (e.g., song) on another user's timeline.

In some embodiments, Step 608 can further involve ranking matches based on which users have the highest matching similarity to the user. In some embodiments, the matching users are displayed individually. In some embodiments, the system is configured to enable a user to individually accept and/or reject each user. In some embodiments, the system is configured to implement a threshold matching level which must be satisfied for a matching user to be included in the identified set of Step 608.

In Step 610, input related to the creation of a songmate is received by engine 300. In some embodiments, this involves the user accepting or rejecting the creation of a songmate relationship for each user of the identified set. In some embodiments, if the user accepts the matching user as songmate, then the accepted user can also be presented with the option to accept by the system. In some embodiments, when both users accept songmate status from another user, a songmate is created, as discussed above. In some embodiments, the system is configured to initiate a communication between songmates (e.g., notification, chat, email, etc.)

In some embodiments, as in Step 610 of the system is configured to create a relationship soundtrack (or mixtape or playlist) compiled based on the songstory of each user in the songmate relationship. In some embodiments, this is automatically determined based on the analysis discussed above in Step 406 of Process 400. In some embodiments, the system is configured to enable users to collectively manage, alter and/or create the soundtrack in a collaborative manner as a form of a shared playlist accessible over a network.

In Step 612, upon the creation of a songmate between two users, interaction can be facilitated that enables the users to directly interact via messages, shared music, shared tokens, and the like, or some combination thereof, as discussed above. For example, as discussed above, a user can create a mixtape of music, and send it (along with a required amount of tokens in some embodiments) as well as render the entire mixtape on another user's device.

In some embodiments, songmates interact via the communication which may comprise video chat and/or telephony functionality provided by the application of engine 300. In some embodiments, the system is configured to determine one or more recreational activities to provide during the communication, such as, but not limited to, trivia related to each user's songstory, karaoke, games, and the like.

In some embodiments, the system is configured generate a DG control interface such that users participating and/or conducting a video (or telephone) are be provided with “DJ” settings that enables them to control the music being played during a call, and/or the speaking and/or video capability of the users during the call (e.g., turn off microphones and/or video capability of another user). In some embodiments, these settings include passes, designated to different users, and/or are shared among users during a call and/or between calls.

In some embodiments, the system is configured to create a group of songmates from a group of users. In some embodiments, rather than having only direct relationships between two users, a plurality of users are included by the system within a single songmate grouping. For example, a family of four (Mom, Dad, Sister and Brother) can being within and/or assigned to a songmate grouping that provides music events related to the upbringing of the Sister and Brother.

In some embodiments, engine 300 enables users to purchase tickets, albums songs, and/or other forms of content. In some embodiments, the purchased items can be shared with other songmates via in-app functionality of engine 300's application.

In some embodiments, engine 300 is provided with functionality to recommend content (e.g., music) to a user based on one or more of their songstory, songmates, real-world activity (e.g., current location and/or forecasted location (e.g., from their calendar), for example), digital activity (e.g., articles they are/have been reading, for example), and the like, or some combination thereof. In some embodiments, the recommended music include radio stations, real-time compiled playlists, preloaded playlists, and the like, or some combination thereof.

In some embodiments, users below a particular age limit (e.g., 18 years old) may have another user (e.g., parent) designated as their “guardian”. This enables them to oversee all activity on the application until the user turns the age limit. In some embodiments, the guardian can be provided with parental control that can include, but are not limited to, accepting/declining songmates for the user, controlling and/or managing which music is listened to, control time spent on the application, and the like.

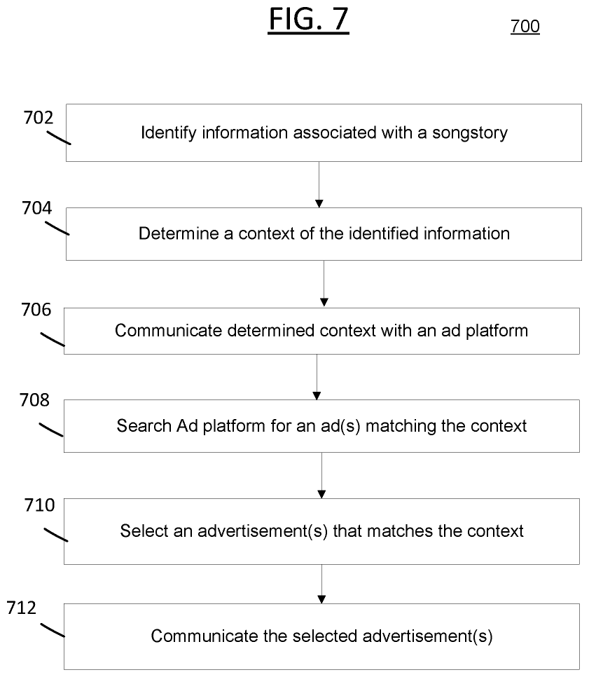

FIG. 7 is a workflow process 700 for serving or providing related digital media content based on a songstory of a user (or other form of profile information of a user), as discussed above in relation to FIGS. 4-6. For example, a user's songstory can indicate their musical tastes and/or experiences (e.g., music preferences) which is leveraged by the system to provide the user with related content. In some embodiments, the provided content comprises advertisements (e.g., digital advertisement content). Such information can be referred to as “songstory information” for reference purposes only.

As discussed above, reference to an “advertisement” should be understood to include, but not be limited to, digital media content that provides information provided by another user, service, third party, entity, and the like. Such digital ad content can include any type of known or to be known media renderable by a computing device, including, but not limited to, video, text, audio, images, and/or any other type of known or to be known multi-media. In some embodiments, the digital ad content can be formatted as hyperlinked multi-media content that provides deep-linking features and/or capabilities. Therefore, while the content is referred as an advertisement, it is still a digital media item that is renderable by a computing device, and such digital media item comprises digital content relaying promotional content provided by a network associated third party.

In Step 702, songstory information is identified by the system. In some embodiments, this information is derived, determined, based on or otherwise identified from the steps of Processes 400 and 600, as discussed above.

In Step 704, a context is determined by the system based on the identified songstory information. In some embodiments, this context forms a basis for serving content related to the songstory and/or user associated with the songstory, as discussed above. In some embodiments, the context can provide an indication of a user's interests and/or identity, and/or actions (e.g., matches and/or shared music, for example), as discussed above in relation to Processes 400 and 600.

In some embodiments, the identification of the context from Step 704 occurs one or more of before, during and/or after the analysis detailed above with respect to FIGS. 4 and/or 6, or it can be a separate process altogether, or some combination thereof.

In Step 706, the determined context is communicated (or shared) with a content providing platform comprising a server and database (e.g., content server 106 and content database 107, and/or advertisement server 130 and ad database). Upon receipt of the context, the server performs (e.g., is caused to perform as per instructions received from the device executing the engine 300) a search for a relevant digital content within the associated database. The search for the content is based at least on the identified context.

In Step 708, the server searches the database for a digital content item(s) that matches the identified context. In Step 710, a content item is selected (or retrieved) based on the results of Step 708.

For example, a content item includes a coupon for purchasing a ticket to the concert of a user's current favorite artist. In another example, the content item includes a coupon or discount code embedded or deep linked within a message or a provided image of an artist in relation to purchasing one of their albums from an online store.

In some embodiments, the selected content item can be modified to conform to attributes or capabilities of a device, browser user interface (UI), video, page, interface, platform, application or method upon which a user will be viewing their songstory, the content item, shared music and/or songmates. In some embodiments, the selected content item is shared or communicated via the application or browser the user is utilizing. Step 712. In some embodiments, the selected content item is sent directly to a user computing device for display on a device and/or within a graphical user interface (GUI) displayed on the device's display (e.g., within the browser window and/or within an inbox of a high-security network property). In some embodiments, the selected content item is displayed within a portion of the interface or within an overlaying or pop-up interface associated with a rendering interface displayed on the device.

It should be understood that while the discussion herein generally discusses content being received, personalized and displayed/rendered on a device, such content can include any type of known or to be known content, such as, but not limited to, webpages, content items on a page, media items, text, graphics, video, images, multimedia objects, advertisements, and the like.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

The disclosure describes the specifics of how a machine including one or more computers comprising one or more processors and one or more non-transitory computer readable media implement the system and its improvements over the prior art. The instructions executed by the machine cannot be performed in the human mind or derived by a human using a pen and paper but require the machine to convert process input data to useful output data. Moreover, the claims presented herein do not attempt to tie-up a judicial exception with known conventional steps implemented by a general-purpose computer; nor do they attempt to tie-up a judicial exception by simply linking it to a technological field. Indeed, the systems and methods described herein were unknown and/or not present in the public domain at the time of filing, and they provide technologic improvements advantages not known in the prior art. Furthermore, the system includes unconventional steps that confine the claim to a useful application.

It is understood that the system is not limited in its application to the details of construction and the arrangement of components set forth in the previous description or illustrated in the drawings. The system and methods disclosed herein fall within the scope of numerous embodiments. The previous discussion is presented to enable a person skilled in the art to make and use embodiments of the system. Any portion of the structures and/or principles included in some embodiments can be applied to any and/or all embodiments: it is understood that features from some embodiments presented herein are combinable with other features according to some other embodiments. Thus, some embodiments of the system are not intended to be limited to what is illustrated but are to be accorded the widest scope consistent with all principles and features disclosed herein.

Some embodiments of the system are presented with specific values and/or setpoints. These values and setpoints are not intended to be limiting and are merely examples of a higher configuration versus a lower configuration and are intended as an aid for those of ordinary skill to make and use the system.

Any text in the drawings is part of the system's disclosure and is understood to be readily incorporable into any description of the metes and bounds of the system. Any functional language in the drawings is a reference to the system being configured to perform the recited function, and structures shown or described in the drawings are to be considered as the system comprising the structures recited therein. Any figure depicting a content for display on a graphical user interface is a disclosure of the system configured to generate the graphical user interface and configured to display the contents of the graphical user interface. It is understood that defining the metes and bounds of the system using a description of images in the drawing does not need a corresponding text description in the written specification to fall with the scope of the disclosure.

Furthermore, acting as Applicant's own lexicographer, Applicant imparts the explicit meaning and/or disavow of claim scope to the following terms:

Applicant defines any use of “and/or” such as, for example, “A and/or B,” or “at least one of A and/or B” to mean element A alone, element B alone, or elements A and B together. In addition, a recitation of “at least one of A, B, and C,” a recitation of “at least one of A, B, or C,” or a recitation of “at least one of A, B, or C or any combination thereof” are each defined to mean element A alone, element B alone, element C alone, or any combination of elements A, B and C, such as AB, AC, BC, or ABC, for example.

“Substantially” and “approximately” when used in conjunction with a value encompass a difference of 5% or less of the same unit and/or scale of that being measured.

“Simultaneously” as used herein includes lag and/or latency times associated with a conventional and/or proprietary computer, such as processors and/or networks described herein attempting to process multiple types of data at the same time. “Simultaneously” also includes the time it takes for digital signals to transfer from one physical location to another, be it over a wireless and/or wired network, and/or within processor circuitry.

As used herein, “can” or “may” or derivations there of (e.g., the system display can show X) are used for descriptive purposes only and is understood to be synonymous and/or interchangeable with “configured to” (e.g., the computer is configured to execute instructions X) when defining the metes and bounds of the system. The phrase “configured to” also denotes the step of configuring a structure or computer to execute a function in some embodiments.

In addition, the term “configured to” means that the limitations recited in the specification and/or the claims must be arranged in such a way to perform the recited function: “configured to” excludes structures in the art that are “capable of” being modified to perform the recited function but the disclosures associated with the art have no explicit teachings to do so. For example, a recitation of a “container configured to receive a fluid from structure X at an upper portion and deliver fluid from a lower portion to structure Y” is limited to systems where structure X, structure Y, and the container are all disclosed as arranged to perform the recited function. The recitation “configured to” excludes elements that may be “capable of” performing the recited function simply by virtue of their construction but associated disclosures (or lack thereof) provide no teachings to make such a modification to meet the functional limitations between all structures recited. Another example is “a computer system configured to or programmed to execute a series of instructions X, Y, and Z.” In this example, the instructions must be present on a non-transitory computer readable medium such that the computer system is “configured to” and/or “programmed to” execute the recited instructions: “configure to” and/or “programmed to” excludes art teaching computer systems with non-transitory computer readable media merely “capable of” having the recited instructions stored thereon but have no teachings of the instructions X, Y, and Z programmed and stored thereon. The recitation “configured to” can also be interpreted as synonymous with operatively connected when used in conjunction with physical structures.

It is understood that the phraseology and terminology used herein is for description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The previous detailed description is to be read with reference to the figures, in which like elements in different figures have like reference numerals. The figures, which are not necessarily to scale, depict some embodiments and are not intended to limit the scope of embodiments of the system.

Any of the operations described herein that form part of the invention are useful machine operations. The invention also relates to a device or an apparatus for performing these operations. All flowcharts presented herein represent computer implemented steps and/or are visual representations of algorithms implemented by the system. The apparatus can be specially constructed for the required purpose, such as a special purpose computer. When defined as a special purpose computer, the computer can also perform other processing, program execution or routines that are not part of the special purpose, while still being capable of operating for the special purpose. Alternatively, the operations can be processed by a general-purpose computer selectively activated or configured by one or more computer programs stored in the computer memory, cache, or obtained over a network. When data is obtained over a network the data can be processed by other computers on the network, e.g., a cloud of computing resources.

The embodiments of the invention can also be defined as a machine that transforms data from one state to another state. The data can represent an article, that can be represented as an electronic signal and electronically manipulate data. The transformed data can, in some cases, be visually depicted on a display, representing the physical object that results from the transformation of data. The transformed data can be saved to storage generally, or in particular formats that enable the construction or depiction of a physical and tangible object. In some embodiments, the manipulation can be performed by a processor. In such an example, the processor thus transforms the data from one thing to another. Still further, some embodiments include methods can be processed by one or more machines or processors that can be connected over a network. Each machine can transform data from one state or thing to another, and can also process data, save data to storage, transmit data over a network, display the result, or communicate the result to another machine. Computer-readable storage media, as used herein, refers to physical or tangible storage (as opposed to signals) and includes without limitation volatile and non-volatile, removable, and non-removable storage media implemented in any method or technology for the tangible storage of information such as computer-readable instructions, data structures, program modules or other data.

Although method operations are presented in a specific order according to some embodiments, the execution of those steps do not necessarily occur in the order listed unless explicitly specified. Also, other housekeeping operations can be performed in between operations, operations can be adjusted so that they occur at slightly different times, and/or operations can be distributed in a system which allows the occurrence of the processing operations at various intervals associated with the processing, as long as the processing of the overlay operations are performed in the desired way and result in the desired system output.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

What is claimed is:

1. A system comprising:
one or more computers comprising one or more processors and one or more non-transitory computer readable media, the one or more non-transitory computer readable media comprising instructions stored thereon that when executed cause the one or more computers to implement steps comprising:
displaying, by the one or more processors, a request for first information of a first user on a graphical user interface (GUI) of a first electronic device;
generating, by the one or more processors, a first profile including one or more visual representations of one or more portions of a first identity of the first user and/or one or more first user interests;
compiling, by the one or more processors, a query of one or more other user profiles, the query configured to enable a match between the first profile and at least a second profile of a second user;
determining, by the one or more processors, overlapping interests between the first user and the second user; and
returning a match if the overlapping interests exceed a certain threshold.

2. The system of claim 1,
wherein the one or more visual representations include a songstory.

3. The system of claim 2,
wherein the songstory includes a timeline.

4. The system of claim 2,
wherein the songstory includes one or more musical preferences.

5. The system of claim 2,
wherein the songstory includes at least one timeline; and
wherein the songstory includes one or more musical preferences.

6. The system of claim 5,
wherein the one or more musical preferences include one or more songs;
wherein the at least one timeline comprises one or more life events; and
wherein songstory comprises a visual representation of the one or more songs at intervals along the at least one timeline.

7. The system of claim 6,
wherein the one or more songs are each associated with at least one of the one or more life events on the timeline.

8. The system of claim 6,
wherein the songstory includes a discography.

9. The system of claim 1,
wherein the steps further comprise:
presenting, by the one or more processors, an option on the GUI for the first user to approve the match; and
designating, by the one or more processors, the first user and the second user as songmates;
wherein the designation enables interaction and sharing of content between the songmates.

10. The system of claim 9,
wherein the one or more visual representations and/or the content include a songstory.

11. The system of claim 10,
wherein the songstory includes at least one timeline; and
wherein the songstory includes one or more musical preferences.

12. The system of claim 11,
wherein the one or more musical preferences include one or more songs;
wherein the at least one timeline comprises one or more life events; and
wherein songstory comprises a visual representation of the one or more songs at intervals along the at least one timeline.

13. The system of claim 12,
wherein the steps further comprise:
generating, by the one or more processors, a scraping of a first social media history of the first user; and
generating, by the one or more processors, at least part of the songstory based on the scraping.

14. The system of claim 12,
wherein the steps further comprise:
generating, by the one or more processors, a match type input on the GUI.

15. The system of claim 14,
wherein the match type input comprises a type of relationship the first user desires to form.
